(19) United States
(12) Patent Application Publication
(10) Pub. No.: US 2004/0033443 A1
(43) Pub. Date: Feb. 19, 2004

(54) Method of manufacturing a semiconductor device

(75) Inventors: O-lk Kwon, Seongnam-si (KR); Jae-woo Kim, Seongnam-si (KR); Seung-joo Yoo, Yongin-si (KR)

Correspondence Address: F. CHAU & ASSOCIATES, LLP, Suite 501, 1900 Hempstead Turnpike, East Meadow, NY, 11554, US

(73) Assignee: Samsung Electronics Co., Ltd.

(21) Appl. No.: 10/445,425

(22) Filed: May 27, 2003

(30) Foreign Application Priority Data
Aug. 19, 2002 (KR) 2002-48980

(51) Int. Cl. B32B 3/10

(52) U.S. Cl. 430/312; 430/314; 430/317; 430/316; 430/329; 428/138

(57) ABSTRACT

A method and corresponding article of manufacture are provided for manufacturing a semiconductor device with contact holes of the same step formed by two photolithography processes, where the manufacture includes forming a photoresist pattern by a first photolithography process on an insulating interlayer in which a first contact hole is formed, the photoresist pattern covering the first contact hole, etching the insulating interlayer to form a second contact hole by using the photoresist pattern as an etching mask, partially removing the photoresist pattern to remove an etch by-product from the second contact hole, and performing a process on the second contact hole by using the photoresist pattern residue as a mask to thereby decrease the number of photo processes and simplify the manufacturing process.

### BACKGROUND OF THE INVENTION

1. Field of the Invention

The present invention relates to semiconductor manufacturing, and more particularly, to a method of manufacturing that is capable of decreasing the number of photo processes when a photolithography process is performed.

2. Description of the Related Art

As patterns of semiconductor devices become smaller, there is a corresponding reduction in the diameters of contact holes, in which a high conductive thin film connects a lower layer (e.g., a diffusion layer formed in a semiconductor substrate) to an upper layer. In cases where the sizes of the contact holes to be formed in the same step are different and the space between these contact holes is relatively narrow, a photolithography process is typically performed twice in order to form the contact holes.

Examples of this technique are disclosed in Japanese Patent Laid Open Publication No. 5-21369, Japanese Patent Laid-Open Publication No. 7-86195 and Japanese Patent Laid-Open Publication No. 9-102469. Particularly, Japanese Patent Laid-Open Publication No. 5-21369 discloses a method of exposing only resist corresponding to a diffusion layer in which no ion implantation is carried out.

FIGS. 1A to 1D are cross-sectional views of a semiconductor device used for illustrating a conventional method of manufacturing.

Referring to FIG. 1A, an insulating interlayer 16 made of an oxide is formed on a semiconductor substrate 10 in which an n+ diffusion layer 12 and a p+ diffusion layer 14 are formed.

Then, a first photo process is carried out to form a first photoresist pattern 18 over the insulating interlayer 16 and further defining the area of n+ diffusion layer 12. Using the first photoresist pattern 18 as an etching mask, the insulating interlayer 16 is dry-etched away to form a first contact hole 20 exposing the n+ diffusion layer 12. At this time, a polymer-based first etch by-product 21 is generated on the first contact hole 20.

Referring to FIG. 1B, the first photoresist pattern 18 is removed by ashing and stripping processes. Then, a second photoresist pattern 22 covering the first contact hole 20 is formed over the insulating interlayer 16 by a second photo process. The first etch by-product 21 on the first contact hole 20 is removed by the above ashing process.

Using the second photoresist pattern 22 as an etching mask, the insulating interlayer 16 is dry-etched away to form a second contact hole 24 exposing the p+ diffusion layer 14. At this time, a polymer-based second etch by-product 25 is generated on the second contact hole 20.

Referring to FIG. 1C, ashing and stripping processes are carried out in order to remove the second photoresist pattern 22. Here, the second etch by-product 25 on the contact hole 24 is removed by the above ashing process.

Referring to FIG. 1D, a third photo process is performed to form a third photoresist pattern 26 covering the first contact hole 20 on the insulating interlayer 16. Using the third photoresist pattern 26 as an etching mask, a p-type impurity 28 is ion-implanted in the p+ diffusion layer 14 located at the bottom of the second contact hole 24.

According to the above-described prior art method, two photolithography processes are carried out to form the contact holes 20 and 24 on the n+ diffusion layer 12 and the p+ diffusion layer 14, respectively. Further, an additional photo process for masking the first contact hole 20 on the n+ diffusion layer 12 is necessary to perform the ion-implantation process for reducing the resistance of p+ diffusion layer 14. Therefore, in order to perform the ion-implantation of the contact hole by the conductive type (n-type and p-type), three photo processes are necessary in total.

Meanwhile, as the integration of semiconductor devices increase, the contact margin between the lower layer and the upper layer becomes relatively shorter, which results in the introduction of a contact structure where the upper layer does not overlap with the lower layer. In this structure, the contact holes are formed through two photolithography processes as the space between the contact holes becomes narrower.

FIGS. 2A to 2D are cross-sectional views illustrating a method of manufacturing a semiconductor device in which a contact hole is formed extending over an active region and a field region.

Referring to FIG. 2A, an etching stop layer 54 made of a nitride and an insulating interlayer 56 made of an oxide are successively formed on a semiconductor substrate 50 that is divided into an active region 51 and field regions 52. The etching stop layer 54 protects the field regions 52 in a subsequent contact etching process.

Next, a first photo process is carried out to form a first photoresist pattern 58 on the insulating interlayer 56. Using the first photoresist pattern 58 as an etching mask, the insulating interlayer 56 of a first area is dry-etched away to form a first contact hole 60 exposing a portion of the surface of a field region 52 and the surface of the substrate 50 adjacent to the field region 52. At this time, a polymer-based first etch by-product 61 is generated in the first contact hole 60.

Referring to FIG. 2B, the first photoresist pattern 58 is removed by ashing and stripping processes, as is the first etch by-product 61 in the first contact hole 60. After removing the etching stop layer 54 in the first contact hole 60 by an etching process, a first impurity 62 is ion-implanted to form a first impurity region 64 in the surface of the substrate located at the bottom of the first contact hole 60.

Referring to FIG. 2C, a photoresist pattern 66 covering the first contact hole 60 is formed on the insulating interlayer 56 through a second photo process. Using the second photoresist pattern 66 as an etching mask, the insulating interlayer 56 of a second area is dry-etched away to form a second contact hole 68 exposing the surface of the substrate adjacent to the field region 52 and a portion of the surface of field region 52. At this time, a polymer-based second etch by-product 69 is generated on the second contact hole 68.

Referring to FIG. 2D, ashing and stripping processes are carried out to remove the second photoresist pattern 66. During the ashing process, the second etch by-product 69 on the second contact hole 68 is also removed.

Next, the etching stop layer 54 in the second contact hole 68 is removed by an etching process so as to ion-implant a second impurity in the surface of the substrate underneath the second contact hole 68. Unfortunately, during the etching process of removing the etching stop layer 54 in the second contact hole 68, the substrate surface exposed through the first contact hole 60 is also etched away to thereby cause junction damages of the first impurity region 64.

In order to prevent this problem, the etching process of removing the etching stop layer 54 on the second contact hole 68 is performed after masking the first contact hole 60 by an additional photo process. Accordingly, three photo processes are necessary for the process of forming the contact hole and the ion-implantation process of the contact hole.

A need therefore exists for a semiconductor manufacturing method requiring fewer than three photo processes while avoiding the above-described drawbacks and disadvantages of the prior art.

### SUMMARY OF THE INVENTION

These and other drawbacks and disadvantages of the prior art are addressed by a method for semiconductor manufacturing having a reduced number of photo processes. Embodiments of the present invention advantageously provide a method of manufacturing a semiconductor device where the method is capable of decreasing the number of photo processes when two photolithography processes form contact holes for the same step.

It is another advantage of the present invention to provide a method of manufacturing a semiconductor device having a contact structure where an upper layer does not overlap with a lower layer, in which the number of photo processes can be decreased. To achieve one advantage of the present invention, according to a method of manufacturing a semiconductor device in which contact holes of the same step are formed through two photolithography processes, a photoresist pattern covering a first contact hole is formed by a first photolithography process on an insulating interlayer having the first contact hole. The insulating interlayer is etched away to form a second contact hole by using the photoresist pattern as an etching mask. The photoresist pattern is partially removed so as to remove an etch by-product on the second contact hole. A subsequent process is carried out on the second contact hole by using the photoresist pattern residue as a mask. Preferably, the step of partially removing the photoresist pattern is carried out through an ashing process.

Further, in a method of manufacturing a semiconductor device according to the present invention, an insulating interlayer is formed on a semiconductor substrate in which a first diffusion layer of a first conductive type and a second diffusion layer of a second conductive type opposite to the first conductive type are formed. The insulating interlayer is etched away to form a first contact hole exposing the first diffusion layer by a first photolithography process. A photoresist pattern covering the first contact hole is formed over the insulating interlayer. The insulating interlayer is etched away to form a second contact hole exposing the second diffusion layer by using the photoresist pattern as an etching mask. The photoresist pattern is partially removed so as to remove an etch by-product on the second contact hole. An impurity of the second conductive type is ion-implanted in the second contact hole by using the photoresist pattern residue as a mask.

According to a method of manufacturing a semiconductor device to achieve another advantage of the present invention, an etching stop layer and an insulating interlayer are sequentially formed on a semiconductor substrate. The insulating interlayer is etched away to form a first contact hole by a first photolithography process. The etching stop layer on the first contact hole is removed. A photoresist pattern covering the first contact hole is formed over the insulating interlayer. The insulating interlayer is etched away to form a second contact hole by using the photoresist pattern as an etching mask. The photoresist pattern is partially removed so as to remove an etch by-product on the second contact hole. The etching stop layer on the second contact hole is removed using the photoresist pattern residue as a mask.

Further, in a method of manufacturing a semiconductor device according to the present invention, an etching stop layer and an insulating interlayer are sequentially formed on a semiconductor substrate divided into an active region and a field region. The insulating interlayer of a first area is etched away by a first photolithography process to form a first contact hole exposing the surface of the substrate adjacent to the field region and a portion of the surface of the field region. The etching stop layer on the first contact hole is removed. A photoresist pattern covering the first contact hole is formed over the insulating interlayer. The insulating interlayer of a second area is etched away by using the photoresist pattern as an etching mask to thereby form a second contact hole exposing the surface of the substrate adjacent to the field region and a portion of the substrate of the field region. The photoresist pattern is partially removed so as to remove an etch by-product on the second contact hole. The etching stop layer on the second contact hole is removed using the photoresist pattern residue as a mask.

According to embodiments of the present invention, when the contact holes of the same step are formed by two photolithography processes, a subsequent process is carried out in masking the contact hole formed in the previous step with the photoresist pattern used to form the last contact hole. Thus, the number of photo processes can be decreased to simplify the manufacturing process.

These and other aspects, features and advantages of the present disclosure will become apparent from the following description of exemplary embodiments, which is to be read in connection with the accompanying drawings.

### BRIEF DESCRIPTION OF THE DRAWINGS

The above and other features and advantages of the present invention will become readily apparent by reference to the following detailed description when considered in conjunction with the accompanying drawings, wherein:

FIGS. 1A to 1D are cross-sectional views illustrating a conventional method of manufacturing a semiconductor device;

FIGS. 2A to 2D are cross-sectional views illustrating another conventional method of manufacturing a semiconductor device;

FIGS. 3A to 3D are cross-sectional views illustrating a method of manufacturing a semiconductor device in accordance with a first embodiment of the present invention; and

FIGS. 4A to 4D are cross-sectional views illustrating a method of manufacturing a semiconductor device in accordance with a second embodiment of the present invention.

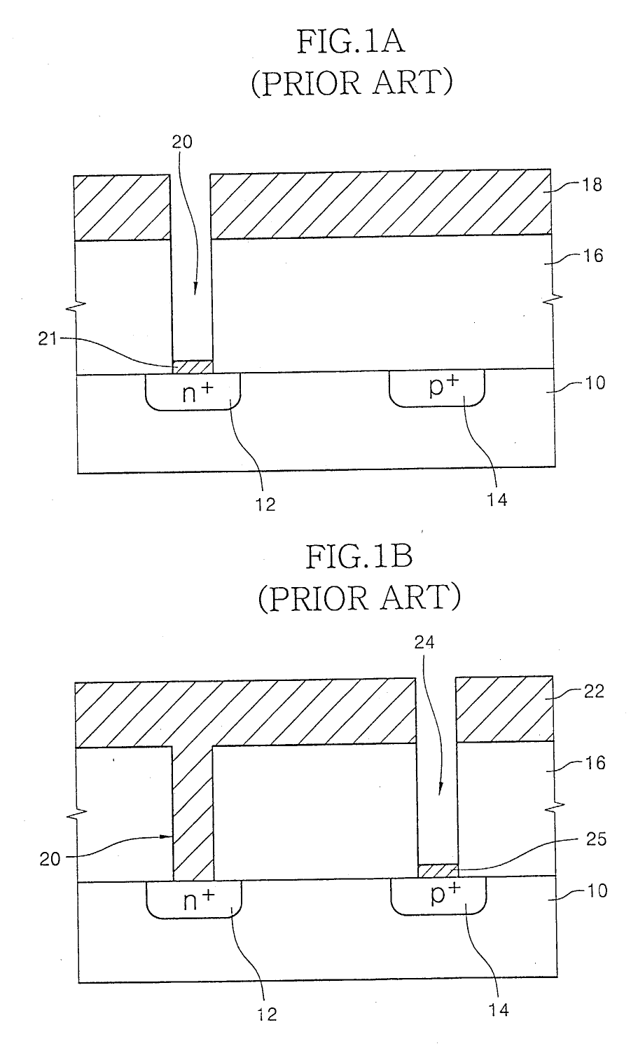

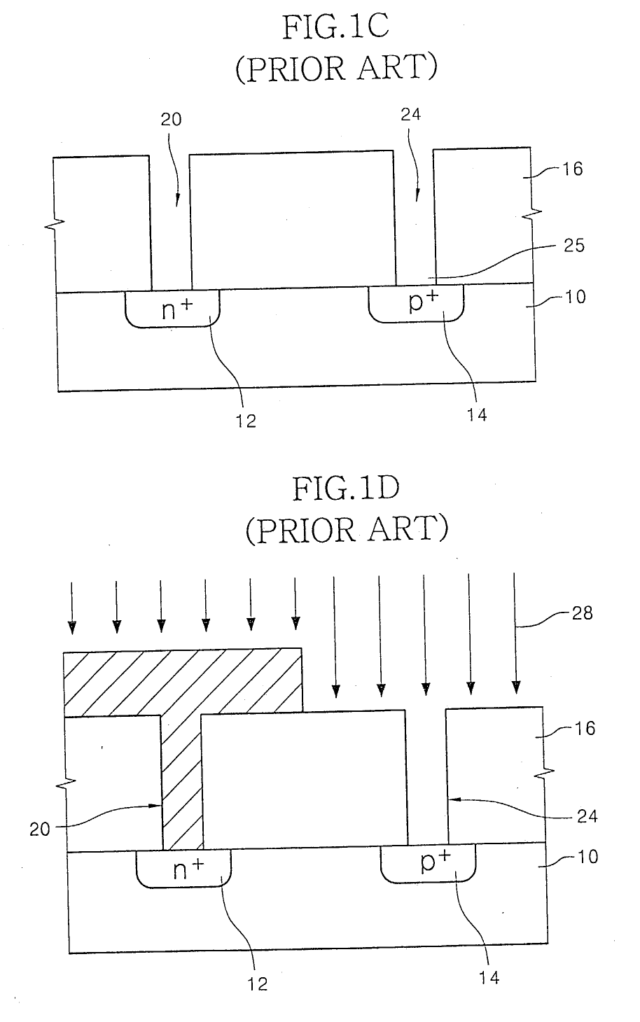

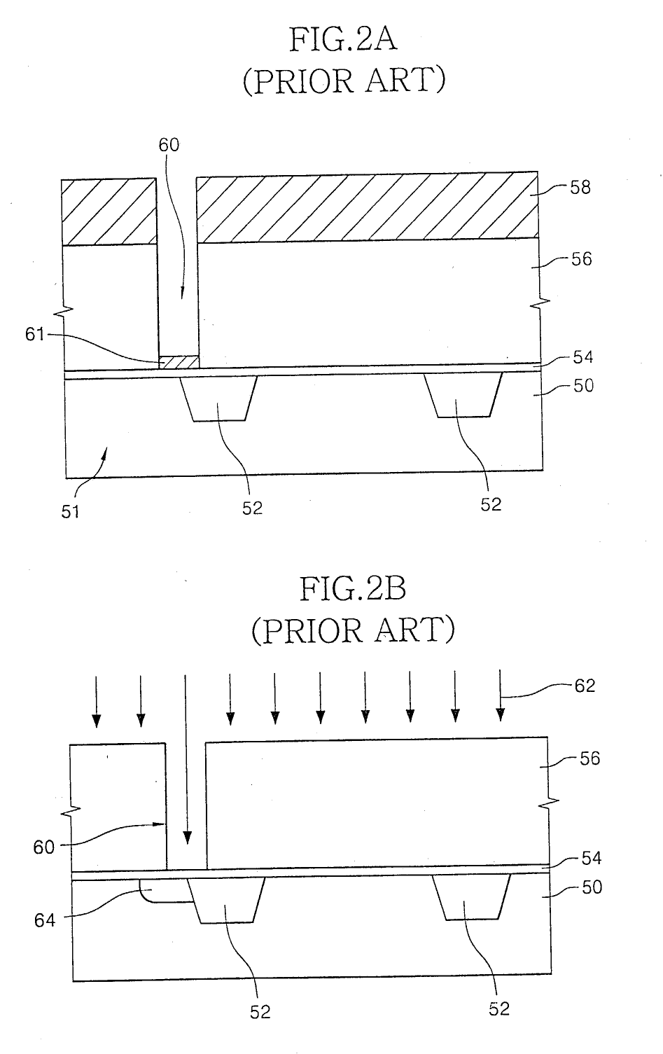

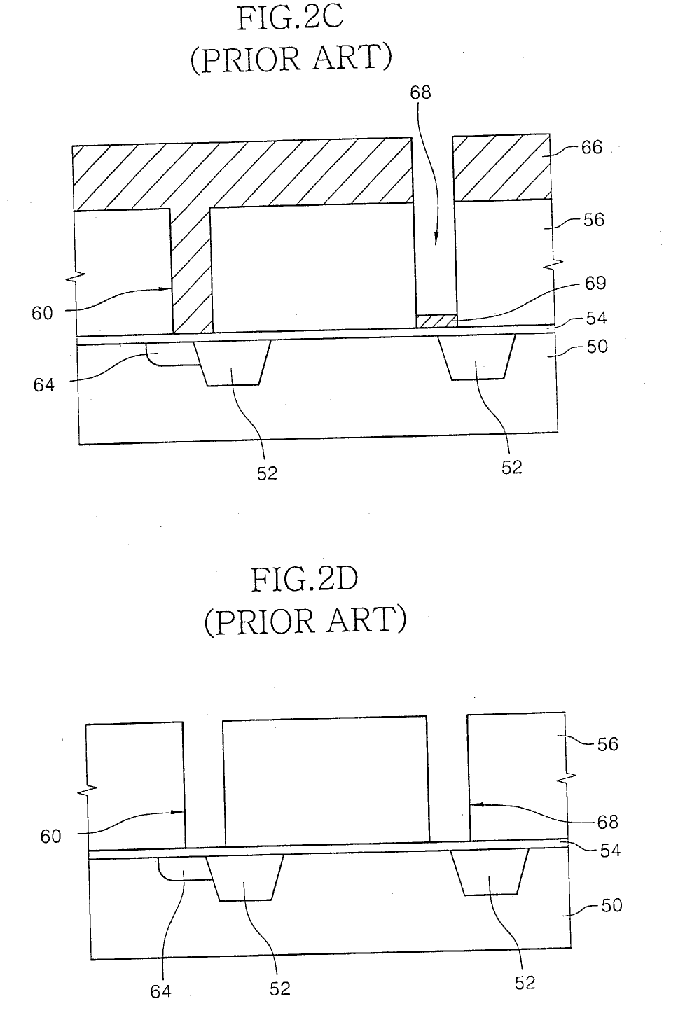

### DESCRIPTION OF PREFERRED EMBODIMENTS

Hereinafter, preferred embodiments of the present invention including a method of manufacturing a semiconductor device and a corresponding article of manufacture will be described in detail with reference to the accompanying drawings, wherein like reference numerals indicate like elements.

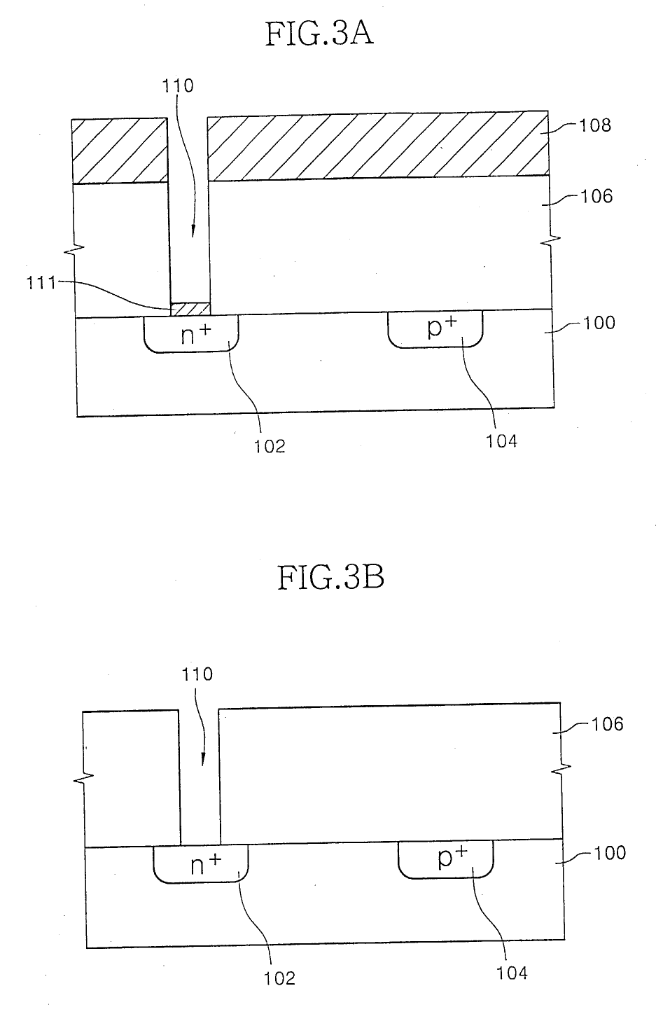

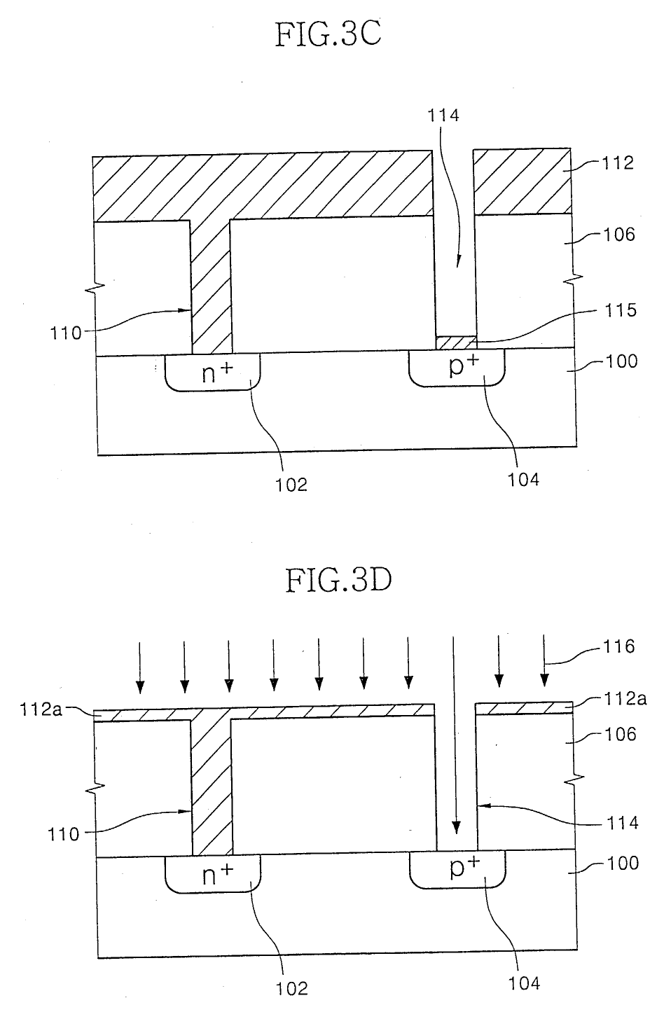

FIGS. 3A to 3D are cross-sectional views illustrating a method of manufacturing a semiconductor device in accordance with a first embodiment of the present invention.

Referring to FIG. 3A, after forming various elements (not shown) such as transistors, capacitors, and the like on a semiconductor substrate 100 in which an n+ diffusion layer 102 and a p+ diffusion layer 104 are formed, an insulating interlayer 106 comprising an oxide is formed on the entire surface of the resultant substrate.

A first photo process is carried out to form a first photoresist pattern 108 defining the area of n+ diffusion layer 102 over the insulating interlayer 106. Using the first photoresist pattern 108 as an etching mask, the insulating interlayer 106 is dry-etched away by a CxFy-based (wherein x and y are positive numbers) etching gas to thereby form a first contact hole 110 exposing the n' diffusion layer 102. At this time, a polymer-based first etch by-product 111 is generated in the first contact hole 110.

Referring to FIG. 3B, the first photoresist pattern 108 is removed by ashing and stripping processes. During the ashing process, the first etch by-product 111 in the first contact hole 110 is also removed.

Referring to FIG. 3C, a second photoresist pattern 112 covering the first contact hole 110 is formed on the insulating interlayer 16 through a second photo process. Next, using the second photoresist pattern 112 as an etching mask, the insulating interlayer 106 is dry-etched away by a CxFy based etching gas to thereby form a second contact hole 114 exposing the p+ diffusion layer 104. At this time, a polymer-based second etch by-product 115 is generated in the second contact hole 114.

Referring to FIG. 3D, an ashing process is carried out so as to remove the second etch by-product 115 from the second contact hole 114. By doing so, the second photoresist pattern 112 is partially removed to completely expose the surface of the substrate underneath the second contact hole 114, while masking the first contact hole 110 with the second photoresist pattern residue 112a.

The ashing process can be performed so that the second photoresist pattern 112 remains to have a predetermined thickness over the insulating interlayer 106, as shown in the figure. Alternatively, the ashing process can be performed such that a portion of the second photoresist pattern 112 remains within the first contact hole 110 while the other portion of the second photoresist pattern 112 on the insulating interlayer 106 is completely removed.

Next, using the second photoresist pattern residue 112a as a mask, a p-type impurity 116 is ion-implanted in the p+ diffusion layer 104 located at the bottom of the second contact hole 114. This ion-implantation process increases the doping concentration of the p+ diffusion layer 104 to reduce the resistance.

Then, the second photoresist pattern residue 112a is removed through ashing and stripping processes.

According to the first embodiment of the present invention, the second photoresist pattern 112 used to form the second contact hole 114 is partially removed to perform a subsequent process, such as p-type impurity ion implantation, after the first and second contact holes 110 and 114 are formed on the n+ diffusion layer 102 and the p+ diffusion layer 104, respectively. Therefore, two photo processes are used to perform the ion-implantation of the contact hole by the n-type and p-type, so that one photo process can be omitted as compared to the prior art.

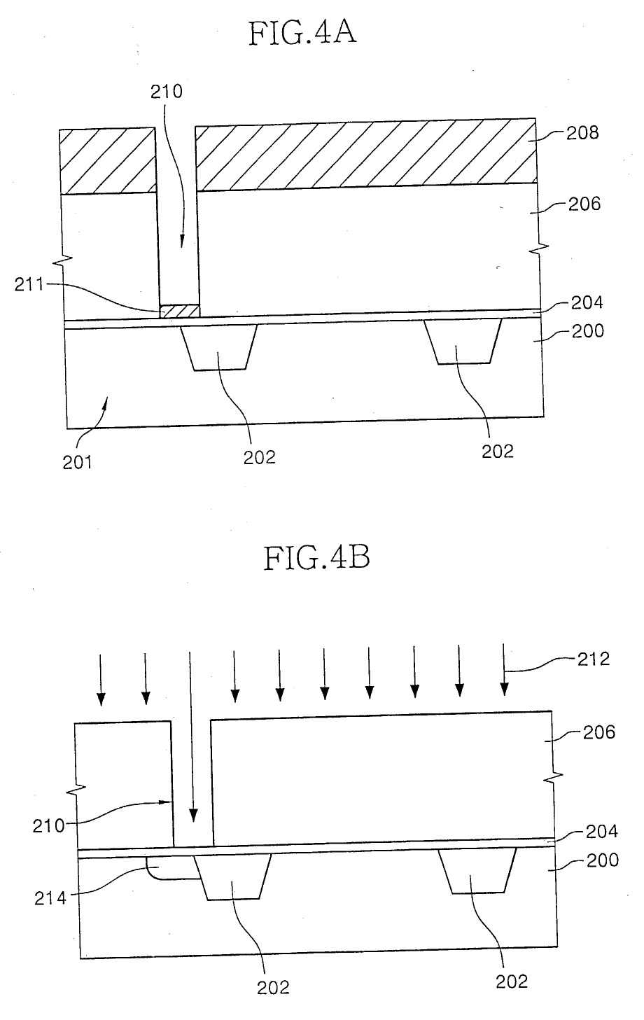

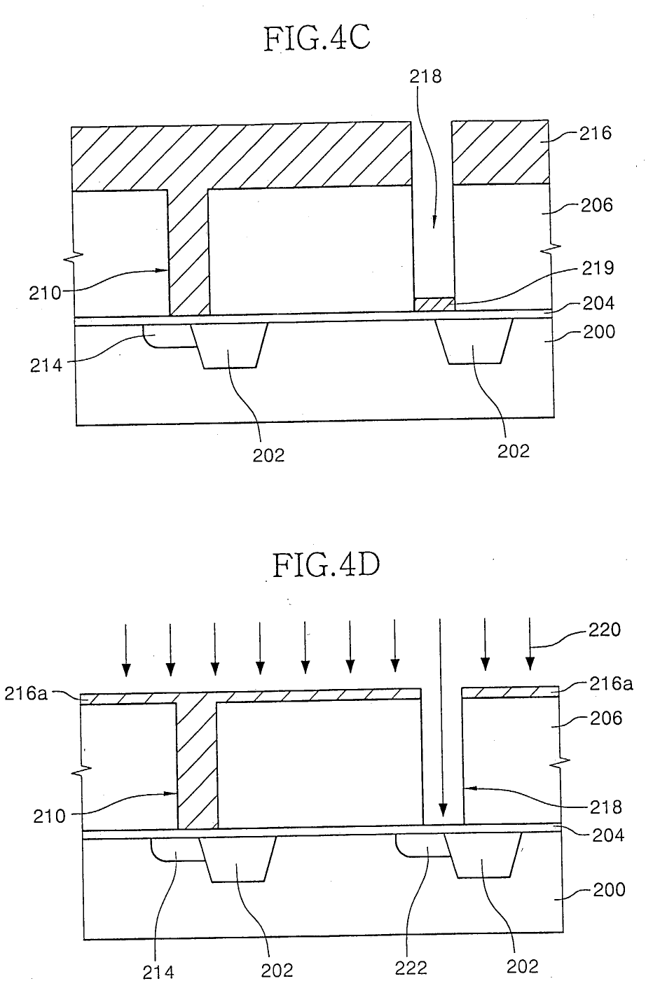

FIGS. 4A to 4D are cross-sectional views illustrating a method of manufacturing a semiconductor device in accordance with a second embodiment of the present invention. Here, a contact hole is formed extending over an active region and a field region because a margin of forming the contact hole on the active region is short.

Referring to FIG. 4A, an isolation process such as trench isolation is carried out on a semiconductor substrate 200, thereby dividing the substrate 200 into an active region 201 and field regions 202. Then, after forming various elements (not shown) such as transistors, capacitors, and the like on the substrate 202, an etching stop layer 204 comprising a nitride such as SiN or SiON is formed on the entire surface of the resultant substrate. The etching stop layer 204 prevents a portion of the field region 202 from being etched when the insulating interlayer is etched away. The field region 202 will comprise a material similar to an insulating interlayer deposited thereon. The stop layer 204 prevents a portion of the field region 202 from being etched when the insulating interlayer is etched away to form a contact hole extending to a portion of the surface of the field region 202 from the surface of the substrate 200 adjacent to the field region 202.

An insulating interlayer 206 comprising an oxide is formed on the etching stop layer 204. Here, an etch-back process or a chemical mechanical polishing (“CMP”) process may be performed to planarize the surface of the insulating interlayer 206.

A first photoresist pattern 208 defining a first area is formed on the insulating interlayer 206 through a first photo process. Using the first photoresist pattern 208 as an etching mask, the insulating interlayer 206 of the first area is etched away by a dry etching process with a gas having the high etch selectivity of the insulating interlayer 206 comprising an oxide over the etching stop layer 204 comprising a nitride. Thus, there is formed a first contact hole 210 exposing the surface of the substrate adjacent to the field region 202 and a portion of the surface of the field region 202. Here, a polymer-based first etch by-product 211 is generated in the first contact hole 210.

Referring to FIG. 4B, the first photoresist pattern 208 is removed by ashing and stripping processes. During the ashing process, the first etch by-product 211 in the first contact hole 210 is also removed.

The etching stop layer 204 on the exposed first contact hole 210 is dry-etched away using the insulating interlayer 206 as an etching mask. Successively, a first impurity 212 is ion-implanted to form a first impurity region 214 at the surface portion of the substrate underneath the exposed first contact hole 210.

Referring to FIG. 4C, a second photoresist pattern 216 covering the first contact hole 210 is formed on the insulating interlayer 206 through a second photo process. Using the second photoresist pattern 216 as an etching mask, the insulating interlayer 206 of a second area is dry-etched away to form a second contact hole 218 exposing the surface of the substrate adjacent to the field region 202 and a portion of the surface of field region 202. At this time, a polymer-based second etch by-product 219 is generated on the second contact hole 218.

Referring to FIG. 4D, an ashing process is carried out to remove the second photoresist pattern 219 on the second contact hole 218. By doing so, the second photoresist pattern 216 is partially removed to completely expose the surface of the substrate underneath the second contact hole 218, while masking the first contact hole 210 with the second photoresist pattern residue 216a.

The ashing process can be performed such that the second photoresist pattern 216 remains to have a predetermined thickness over the insulating interlayer 206 as shown in the figure. Alternatively, the ashing process can be performed such that a portion of the second photoresist pattern 216 within the first contact hole 210 remains while another portion of the second photoresist pattern 216 on the insulating interlayer 206 is completely removed.

Next, the etching stop layer 204 on the exposed second contact hole 218 is removed through a dry etching process using the second photoresist pattern residue 216a as an etching mask. Successively, a second impurity 220 is ion-implanted to form a second impurity region 222 in the surface portion of the substrate underneath the exposed second contact hole 218.

According to the second embodiment of the present invention, without an additional photo process, an etching process of removing the etching stop layer 204 on the second contact hole 218 is performed while masking the area of the first contact hole 210 with the second photoresist pattern 216, which was used to form the second contact hole 218. Therefore, the generation of junction damages may be prevented in the first impurity region 214 underneath the first contact hole 210 with the presently disclosed etching process.

In a method of manufacturing a semiconductor device according to the present invention as described above, when the contact holes of the same step are formed by two photolithography process, a subsequent process is carried out in masking the contact hole formed in the previous step with the photoresist pattern used to form the last contact hole. Thus, the number of photo processes can be decreased to simplify the manufacturing process.

Although preferred embodiments of the present invention have been described, it is to be understood that the present invention should not be limited to these preferred embodiments, but that various changes and modifications can be made by one of ordinary skill in the pertinent art without departing from the scope or sprit of the present invention as hereinafter claimed.

What is claimed is:

1. A method of manufacturing a semiconductor device in which contact holes of the same step are formed by two photolithography processes, the method comprising the steps of:
forming a photoresist pattern by a first photolithography process on an insulating interlayer in which a first contact hole is formed, the photoresist pattern covering the first contact hole;
etching the insulating interlayer to form a second contact hole by using the photoresist pattern as an etching mask;
partially removing the photoresist pattern to remove an etch by-product from the second contact hole; and
performing a process on the second contact hole by using the photoresist pattern residue as a mask.

2. The method as claimed in claim 1, wherein the step of partially removing the photoresist pattern is carried out through an ashing process.

3. The method as claimed in claim 1, wherein the process performed on the second contact hole is an ion-implantation process.

4. A method of manufacturing a semiconductor device comprising the steps of:
forming an insulating interlayer on a semiconductor substrate in which a first diffusion layer of a first conductive type and a second diffusion layer of a second conductive type are formed;
etching the insulating interlayer by a first photolithography process to form a first contact hole exposing the first diffusion layer;
forming a photoresist pattern covering the first contact hole over the insulating interlayer;
etching the insulating interlayer to form a second contact hole exposing the second diffusion layer by using the photoresist pattern as an etching mask;
partially removing the photoresist pattern to remove an etch by-product on the second contact hole; and
ion-implanting an impurity of the second conductive type in the second contact hole by using the photoresist pattern residue as a mask.

5. The method as claimed in claim 4, wherein the step of forming the first contact hole by the first photolithography process comprises the sub-steps of:
forming a first photoresist pattern on the insulating interlayer;
etching the insulating interlayer to form the first contact hole by using the first photoresist pattern as an etching mask; and
removing the first photoresist pattern.

6. The method as claimed in claim 4, wherein the step of partially removing the photoresist pattern is carried out through an ashing process.

7. A method of manufacturing a semiconductor device comprising the steps of:
sequentially forming an etching stop layer and an insulating interlayer on a semiconductor substrate;
etching the insulating interlayer by a first photolithography process to form a first contact hole;
removing the etching stop layer from the first contact hole;
forming a photoresist pattern covering the first contact hole over the insulating interlayer;
etching the insulating interlayer to form a second contact hole by using the photoresist pattern as an etching mask;
partially removing the photoresist pattern so as to remove an etch by-product from the second contact hole; and
removing the etching stop layer from the second contact hole by using the photoresist pattern residue as a mask.

8. The method as claimed in claim 7, wherein the step of forming the first contact hole by the first photolithography process comprises the sub-steps of:
forming a first photoresist pattern on the insulating interlayer;
etching the insulating interlayer to form the first contact hole by using the first photoresist pattern as an etching mask; and
removing the first photoresist pattern.

9. The method as claimed in claim 7, further comprising the step of ion-implanting a first impurity in the first contact hole prior to the step of forming the photoresist pattern.

10. The method as claimed in claim 7, wherein the step of partially removing the photoresist pattern is carried out through an ashing process.

11. The method as claimed in claim 7, further comprising after the step of removing the etching stop layer on the second contact hole:
ion-implanting a second impurity in the second contact hole; and
removing the photoresist pattern residue from the second contact hole.

12. The method as claimed in claim 7, wherein the etching stop layer comprises either silicon nitride or silicon oxynitride.

13. A method of manufacturing a semiconductor device comprising the steps of:
sequentially forming an etching stop layer and an insulating interlayer on a semiconductor substrate divided into an active region and a field region;
etching the insulating interlayer of a first area by a first photolithography process to form a first contact hole exposing the surface of the substrate adjacent to the field region and a portion of the surface of the field region;
removing the etching stop layer from the first contact hole;
forming a photoresist pattern covering the first contact hole over the insulating interlayer;
etching the insulating interlayer of a second area by using the photoresist pattern as an etching mask to thereby form a second contact hole exposing the surface of the substrate adjacent to the field region and a portion of the substrate of the field region;
partially removing the photoresist pattern to remove an etch by-product from the second contact hole; and
removing the etching stop layer from the second contact hole by using the photoresist pattern residue as a mask.

14. The method as claimed in claim 13, wherein the step of forming the first contact hole by the first photolithography process comprises the sub-steps of:
forming a first photoresist pattern on the insulating interlayer;
etching the insulating interlayer to form the first contact hole by using the first photoresist pattern as an etching mask; and
removing the first photoresist pattern.

15. The method as claimed in claim 13, further comprising the step of ion-implanting a first impurity in the first contact hole prior to the step of forming the photoresist pattern.

16. The method as claimed in claim 13, wherein the step of partially removing the photoresist pattern is carried out through an ashing process.

17. The method as claimed in claim 13, further comprising after the step of removing the etching stop layer on the second contact hole:
ion-implanting a second impurity in the second contact hole; and
removing the photoresist pattern residue from the second contact hole.

18. A semiconductor device manufactured with contact holes of the same step formed by two photolithography processes, said manufacture comprising:
forming a photoresist pattern by a first photolithography process on an insulating interlayer in which a first contact hole is formed, the photoresist pattern covering the first contact hole;
etching the insulating interlayer to form a second contact hole by using the photoresist pattern as an etching mask;
partially removing the photoresist pattern to remove an etch by-product from the second contact hole; and
performing a process on the second contact hole by using the photoresist pattern residue as a mask.

19. A semiconductor device as defined in claim 18, said manufacture further comprising:
forming the insulating interlayer on a semiconductor substrate in which a first diffusion layer of a first conductive type and a second diffusion layer of a second conductive type are formed;
exposing the first diffusion layer by etching the insulating interlayer by the first photolithography process to form the first contact hole;
exposing the second diffusion layer by using the photoresist pattern as an etching mask while etching the insulating interlayer to form the second contact hole; and
ion-implanting an impurity of the second conductive type in the second contact hole by using the photoresist pattern residue as a mask.

20. A semiconductor device as defined in claim 18, said manufacture further comprising:
sequentially forming an etching stop layer and the insulating interlayer on a semiconductor substrate;
etching the insulating interlayer by a first photolithography process to form a first contact hole;
removing the etching stop layer from the first contact hole; and
removing the etching stop layer from the second contact hole by using the photoresist pattern residue as a mask.

21. A semiconductor device as defined in claim 18, said manufacture further comprising:
sequentially forming an etching stop layer and an insulating interlayer on a semiconductor substrate divided into an active region and a field region;
etching the insulating interlayer of a first area by the first photolithography process to form the first contact hole exposing the surface of the substrate adjacent to the field region and a portion of the surface of the field region;
removing the etching stop layer on the first contact hole;
etching the insulating interlayer of a second area by using the photoresist pattern as an etching mask to thereby form the second contact hole while exposing the surface of the substrate adjacent to the field region and a portion of the substrate of the field region; and
removing the etching stop layer from the second contact hole by using the photoresist pattern residue as a mask.
